(19) United States
(12) Patent Application Publication
(10) Pub. No.: US 2014/0273541 A1
(43) Pub. Date: Sep. 18, 2014

(54) Electric Hose Swivel For Skimmer Attachment

(71) Applicant: Hayward Industries, Inc., Elizabeth, NJ (US)

(72) Inventors: Benoit Joseph Renaud, Clemmons, NC (US); Jirawat Sumonthee, West Palm Beach, FL (US)

(73) Assignee: Hayward Industries, Inc., Elizabeth, NJ (US)

(21) Appl. No.: 14/208,247

(22) Filed: Mar. 13, 2014

Related U.S. Application Data
(60) Provisional application No. 61/784,853, filed on Mar. 14, 2013.

(51) Int. Cl. H01R 39/64; H01R 43/26; E04H 4/16

(52) U.S. Cl. CPC H01R 39/64; E04H 4/16; H01R 43/26
USPC 439/13; 29/876

(57) ABSTRACT

Exemplary embodiments are directed to modular electric hose swivels for reducing entanglement of a swimming pool cleaner power cable. The exemplary modular electric hose swivels generally include a swivel body that includes a first swivel half and a second swivel half. The first swivel half and the second swivel half are generally configured to receive a first cable and a second cable. The first swivel half and the second swivel half further provide a continuous electrical contact between the first and second cables. The exemplary swivel body can also be detachably secured to a skimmer. Exemplary embodiments are further directed to methods of reducing entanglement of a swimming pool cleaner power cable.

### CROSS-REFERENCE TO RELATED APPLICATIONS

The present application claims the benefit of priority to U.S. provisional patent application No. 61/784,853, filed on Mar. 14, 2013, which is incorporated herein by reference in its entirety.

### TECHNICAL FIELD

The present disclosure relates to modular hose swivels and associated methods and, more particularly, to modular hose swivels for reducing entanglement of swimming pool cleaner power cables by attachment of the modular hose swivels to a skimmer at a water line.

### BACKGROUND

Robotic swimming pool cleaners are generally designed to move along the swimming pool floor and/or walls to clean the necessary surfaces from, e.g., debris, sediment, and the like. The motion of robotic swimming pool cleaners can be preprogrammed, random motion or a combination of the two. This permits a user to activate the swimming pool cleaner and leave it unattended to thoroughly clean the swimming pool without the need for user interaction and/or supervision. In general, electrical power is provided to the robotic swimming pool cleaner through a power cable extending from the swimming pool cleaner and connecting to a power source in the periphery of the swimming pool. Robotic swimming pool cleaner systems can further include a skimmer for collecting leaves and other floating debris along the water line. In addition to the power cable for the swimming pool cleaner, a power cable dedicated to providing electrical power to the skimmer can also be connected to the skimmer directly and generally extends to a power source in the periphery of the swimming pool.

The combination of preprogrammed and/or random motion of the swimming pool cleaner with the plurality of power cables implemented generally creates difficulties with respect to power cable entanglement. In particular, as the swimming pool cleaner moves along the floor and/or walls of the swimming pool, the plurality of power cables implemented can become twisted and/or entangled with, e.g., other power cables, structures around the periphery of the swimming pool, the swimming pool cleaner, or the like, thus limiting the motion of the swimming pool cleaner. Additionally, power cable entanglement creates a need for user interaction and/or supervision to ensure that the swimming pool cleaner can freely move along the entire surface area of the swimming pool floors and/or walls.

As can be seen in FIGS. 1A and 1B, hose swivels generally used in the industry attach, e.g., near the power source, fixedly to the swimming pool cleaner (hose swivel 10), in-line between the water line and the swimming pool cleaner (hose swivel 20), or the like.

Thus, despite efforts to date, a need remains for modular hose swivels for reducing entanglement of swimming pool cleaner power cables, for attachment to a skimmer, for attachment along various positions along a cable and/or hose swivels having other advantageous features.

### SUMMARY

In accordance with embodiments of the present disclosure, exemplary modular hose swivels (hereinafter “hose swivel”) and associated methods for reducing entanglement of a swimming pool cleaner power cable are provided. An exemplary hose swivel as disclosed herein generally includes a swivel body that further includes a first swivel half and a second swivel half. The first swivel half is generally configured to receive a first cable and the second swivel half is configured to receive a second cable. The first and second swivel halves are configured to provide a continuous electrical contact between the first and second cables. The first and second cables are generally axially rotatable relative to each other.

The swivel body can generally be detachably secured to a skimmer. The attachment to the skimmer can be made at a water line of the swimming pool. In some embodiments, the swivel body can be detachably secured to a flange protruding circumferentially from the skimmer. In some embodiments, the flange includes a groove complementary to an outer surface of the swivel body configured and dimensioned to create as nap fit between the groove and the swivel body.

The swivel body can optionally be attached at an in-line position and/or a fixed unit position. In particular, the in-line position generally involves detachably securing the first and second swivel halves to the first and second cables such that the hose swivel is positioned below the water line. The fixed unit position generally involves detachably securing the first swivel half and the second swivel half to the first cable and second cable at a fixed position on a pool cleaner unit.

The first swivel half of an exemplary hose swivel can include a skimmer auxiliary outlet port for providing electrical power from the swivel body to the skimmer. Thus, the first cable electrically connects the swivel body to a power source, the second cable electrically connects the swivel body to the pool cleaner unit, and the skimmer auxiliary outlet port can optionally electrically connect the swivel body to the skimmer upon attachment thereto.

The continuous electrical contact between the first and second cables can be at least one of a vertical electrical contact assembly and a horizontal electrical contact assembly. The vertical electrical contact assembly generally includes, e.g., at least one spring-loaded pin, a pin printed circuit board and a contact printed circuit board. In other embodiments, the vertical electrical contact assembly generally includes, e.g., at least one spring-loaded brush, or the like. The at least one spring-loaded brush can be fabricated from, e.g., carbon graphite, and can function similarly to a permanent magnet of a DC motor. The contact printed circuit board can be, e.g., a copper trace contact printed circuit board. The pin printed circuit board is generally configured and dimensioned to detachably secure the at least one spring-loaded pin in a perpendicular orientation with respect to a surface of the pin printed circuit board. The at least one spring-loaded pin electrically connects the pin printed circuit board and the contact printed circuit board. Further, the at least one spring-loaded pin generally reduces pitting of the contact printed circuit board.

The horizontal electrical contact assembly generally includes a slip ring assembly. The slip ring assembly can include, e.g., a brass contact ring and at least a first pair of brushes. In particular, the at least first pair of brushes are generally fabricated from self-lubricating carbon graphite. In some embodiments, the at least first pair of brushes can be fabricated from, e.g., a carbon graphite composition, a copper graphite composition, a silver graphite composition, and the like. Carbon graphite compositions are unique in that they are adequately conductive to perform electrically and/or have lubricating characteristics to maintain low friction for satisfactory mechanical performance. Copper graphite compositions can have material contents of about 15-95% copper or copper alloy. The added conductivity and lower voltage drop of the metals permits enhanced performance of copper graphite brushes at high current densities and/or low voltages. Silver graphite compositions can have material contents of about 15-95% silver. Similarly to copper graphite brushes, the added conductivity and lower voltage drop of the silver graphite compositions permits enhanced performance of silver graphite brushes at high current densities and low voltages. One end of the at least first pair of brushes generally includes a terminal and/or cap to make a stationary electrical connection.

In accordance with further embodiments of the present disclosure, an exemplary method of reducing entanglement of a swimming pool cleaner power cable is provided. The exemplary method generally includes providing a swivel body that includes a first swivel half and a second swivel half and detachably securing the first swivel half to a first cable and the second swivel half to a second cable. The first swivel half and the second swivel half generally provide a continuous electrical contact between the first and second cables, respectively. The exemplary method can further include detachably securing the swivel body to a skimmer. The first cable can be electrically connected to a power source and the second cable can be electrically connected to a pool cleaner unit. The first swivel half can include a skimmer auxiliary outlet port for providing electrical power from the swivel body to the skimmer.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIGS. 1A and 1B are perspective views of hose swivels as taught by the prior art;

FIGS. 2A and 2B are perspective views of exemplary embodiments of hose swivels according to the present disclosure;

FIG. 3 is a perspective view of a first embodiment of an exemplary hose swivel with a skimmer outlet port;

FIG. 4 is a cross-sectional view of a first embodiment of an exemplary hose swivel of FIG. 3;

FIGS. 5A and 5B are detailed cross-sectional views of a vertical and a horizontal electrical contact assembly of a first embodiment of an exemplary hose swivel of FIG. 3;

FIGS. 6A and 6B are detailed views of a first embodiment of exemplary spring-loaded pins;

FIGS. 7A and 7B are detailed views of a first embodiment of an exemplary vertical electrical contact assembly;

FIGS. 8A and 8B are perspective views of a second embodiment of an exemplary hose swivel according to the present disclosure;

FIG. 9 is a cross-sectional view of a second embodiment of an exemplary hose swivel of FIGS. 8A and 8B;

FIGS. 10A-C are detailed views of a second embodiment of an exemplary vertical electrical contact assembly;

FIGS. 11A and 11B are detailed views of a second embodiment of an exemplary vertical electrical contact assembly;

FIG. 12 is a cross-sectional view of a second embodiment of an exemplary first swivel half of a hose swivel of FIGS. 8A and 8B;

FIGS. 13A and 13B are cross-sectional and perspective views of a second embodiment of an exemplary second swivel half of a hose swivel of FIGS. 8A and 8B;

FIG. 14 is a detailed cross-sectional view of a second embodiment of an exemplary vertical electrical contact assembly of a second embodiment of an exemplary hose swivel of FIG. 13A;

FIGS. 15A-C are detailed views of a first embodiment of exemplary spring-loaded brushes;

FIG. 16 is a perspective view of a third embodiment of an exemplary hose swivel including a first embodiment of a horizontal electrical contact assembly according to the present disclosure;

FIG. 17 is a perspective view of a second embodiment of an exemplary horizontal electrical contact assembly;

FIG. 18 is a perspective view of a second embodiment of an exemplary horizontal electrical contact assembly of FIG. 17;

FIG. 19 is a cross-sectional view of a fourth embodiment of an exemplary hose swivel according to the present disclosure;

FIGS. 20A-E illustrate a cross-sectional view of a fourth embodiment of an exemplary hose swivel of FIG. 19 including a vertical electrical contact assembly and detailed views of a first embodiment of exemplary spring-loaded brushes;

FIG. 21 is a cross-sectional view a fourth embodiment of an exemplary hose swivel of FIG. 19 including a horizontal electrical contact assembly;

FIG. 22 is a perspective view of a fifth embodiment of an exemplary a hose swivel according to the present disclosure;

FIG. 23 is a cross-sectional view of a fifth embodiment of an exemplary hose swivel of FIG. 22;

FIGS. 24A and 24B are perspective and cross-sectional views of a sixth embodiment of an exemplary hose swivel according to the present disclosure;

FIGS. 25A and 25B are cross-sectional views of a sixth embodiment of an exemplary hose swivel of FIGS. 24A and 24B including a vertical electrical contact assembly;

FIG. 26 is a cross-sectional view of a sixth embodiment of an exemplary hose swivel of FIGS. 24A and 24B including a horizontal electrical contact assembly;

FIG. 27 is a cross-sectional view of a seventh embodiment of an exemplary hose swivel according to the present disclosure;

FIG. 28 is a cross-sectional view of a first embodiment of an exemplary embodiment of a skimmer/hose swivel assembly according to the present disclosure including a second embodiment of an exemplary hose swivel of FIGS. 8A and 8B;

FIGS. 29A and 29B are top and bottom views of a first embodiment of an exemplary embodiment of a skimmer/hose swivel assembly of FIG. 28;

FIG. 30 is a perspective view of an eighth embodiment of an exemplary hose swivel including a cable sleeve according to the present disclosure;

FIG. 31 is a perspective view of a ninth embodiment of an exemplary hose swivel according to the present disclosure;

FIG. 32 is a perspective exploded view of a ninth embodiment of an exemplary hose swivel of FIG. 31 including a horizontal electrical contact assembly;

FIG. 33 is a cross-sectional view of a ninth embodiment of an exemplary hose swivel of FIG. 31 including a horizontal electrical contact assembly; and

FIG. 34 is a cross-sectional exploded view of a ninth embodiment of an exemplary hose swivel of FIG. 31 including a horizontal electrical contact assembly.

### DESCRIPTION OF EXEMPLARY EMBODIMENTS

In accordance with embodiments of the present disclosure, exemplary modular hose swivels and associated methods for reducing entanglement of a swimming pool cleaner power cable are provided. An exemplary hose swivel as disclosed herein generally includes a swivel body that further includes a first swivel half and a second swivel half. The first swivel half is generally configured to receive a first cable and the second swivel half is configured to receive a second cable. The first and second swivel halves are configured to provide a continuous electrical contact between the first and second cables. The first and second cables are generally axially rotatable relative to each other.

In accordance with further embodiments of the present disclosure, an exemplary method of reducing entanglement of a swimming pool cleaner power cable is provided. The exemplary method generally includes providing a swivel body that includes a first swivel half and a second swivel half and detachably securing the first swivel half to a first cable and the second swivel half to a second cable. The first swivel half and the second swivel half generally provide a continuous electrical contact between the first and second cables, respectively. The exemplary method can further include detachably securing the swivel body to a skimmer. In addition, the first cable can be electrically connected to a power source and the second cable can be electrically connected to a pool cleaner unit. The first swivel half can include a skimmer auxiliary outlet port for providing electrical power to the skimmer.

Turning now to FIG. 2A, a perspective view of exemplary embodiments of hose swivels 100a, 100b and 100c are provided. The modular hose swivels 100a, 100b and 100c are designed similarly and offer the flexibility of being used as an accessory by optionally positioning one or more of said hose swivels 100a, 100b and 100c at different locations relative to a skimmer 101, a pool cleaner unit 103 and a water line 102. In particular, FIG. 2A illustrates three potential positions of an exemplary hose swivel. Thus, while hose swivel 100a is depicted attached to the skimmer 101 at the waterline, exemplary hose swivels 100b and 100c are illustrated in dashed lines to indicate alternative positions of the hose swivels 100b and 100c between the first and second cables 104 and 105. It should be understood that in other embodiments, more than one hose swivel 100a, 100b and/or 100c can be implemented for, e.g., preventing tangling and/or twisting of commercial and/or power cables which are longer than typically used in the residential swimming pool setting. For example, two, three, four, or the like, hose swivels 100a, 100b and/or 100c can be implemented along the first and/or second cables 104 and 105 to ensure a reduction in tangling of the first and second cables 104 and 105. Due to similar design elements of the exemplary hose swivels 100a, 100b and 100c, other than positioning of the hose swivels 100a, 100b and 100c, it should be understood that a discussion of the hose swivel 100a reflects the design and/or functions of each of the exemplary hose swivels 100a, 100b and 100c.

With respect to positioning, the exemplary hose swivel 100a can be detachably secured to the skimmer 101. The connection between the skimmer 101 and the hose swivel 100a generally occurs at the water line 102, e.g., the “water line” position, and permits the hose swivel 100a to float at the water line 102 with the skimmer 101. However, it should be understood that the hose swivel 100a can be positioned partially below and/or above the water line 102 when connected to the skimmer 101 in the water line 102 position. Similarly, the skimmer 101 can be positioned partially below and/or above the water line 102 during normal operation. A first cable 104 generally electrically connects the hose swivel 100a to a power source (not shown), e.g., a pool cleaner power supply or an electric outlet. A second cable 105 generally electrically connects the hose swivel 100a directly to the pool cleaner unit 103. Simultaneously, a skimmer auxiliary outlet port (see, e.g., FIG. 3) located on the hose swivel 100a can provide electric power to the skimmer 101.

The exemplary hose swivel 100b of FIG. 2A can be detachably secured at an “in-line” position between the first and second cables 104 and 105. In particular, the “in-line” position generally includes detachably securing the hose swivel 100b to a first cable 104 which electrically connects the hose swivel 100b directly to a power source (not shown). A second cable 105 can electrically connect the hose swivel 100b directly to the pool cleaner unit 103. As stated above, it should be understood that when the hose swivel 100b is implemented with the pool cleaner unit 103, the first and second cables 104 and 105 can extend directly from the hose swivel 100b to the power source and the pool cleaner unit 103, respectively.

In some embodiments, a floating attachment 107, e.g., a floating ball, positioned along the first and/or second cables 104 and 105 can be used in conjunction with a hose swivel 100b positioned at an in-line position to assist in lifting up and maintaining the hose swivel 100b in an extending position relative to the pool cleaner unit 103. Although illustrated as a circular floating attachment 107, it should be understood that alternative configurations of the floating attachment 107 can be used. In some embodiments, rather than using the floating attachment 107, the hose swivel 100b housing can be fabricated from a material which acts as a floating device, thereby lifting up and maintaining the hose swivel 100b in an extended position relative to the pool cleaner unit 103. In some embodiments, a combination of the floating attachment 107 and the material of fabrication of the housing for the hose swivel 100b can be used to assist in lifting up and maintaining the hose swivel 100b in an extended position relative to the pool cleaner unit 103.

The exemplary hose swivel 100c can be detachably secured at a fixed position between the first and second cables 104 and 105. In particular, the fixed position generally includes detachably securing the hose swivel 100c to a first cable 104 which electrically connects the hose swivel 100c directly to a power source (not shown). A second cable 105 can electrically connect the hose swivel 100c directly to the pool cleaner unit 103. The hose swivel 100c itself can optionally be fixedly attached to the pool cleaner unit 103 at, e.g., the pool cleaner handle, the pool cleaner body, bracket 106 extending form the pool cleaner body, and the like. In some embodiments, the pool cleaner body can include a side panel and/or pocket (not shown) configured and dimensioned for receiving/installing the hose swivel 100c therein. A removable cover (not shown) can optionally be used to conceal the installed hose swivel 100c. In some embodiments, fixedly attaching the hose swivel 100c to the pool cleaner unit 103 can increase the amount of pull force which can be withstood on the first and/or second cables 104 and 105. Similarly to the hose swivel 100b, it should be understood that when the hose swivel 100c is implemented with the pool cleaner unit 103, the first and second cables 104 and 105 can extend directly from the hose swivel 100c to the power source and the pool cleaner unit 103, respectively.

FIG. 2B illustrates another exemplary attachment of the hose swivel 100c′ to a pool cleaner unit 103′. In particular, the pool cleaner body can include a bracket 106′ connected to the side of the pool cleaner unit 103′ such that the hose swivel 100c′ can be installed therein. The hose swivel 100c′ can thereby be fixedly attached to the pool cleaner unit 103′ and can include a first cable 104′ electrically connecting the hose swivel 100c′ to a power source (not shown), e.g., a pool cleaner power supply or an electric outlet, and a second cable 105′ electrically connecting the hose swivel 100c′ to the pool cleaner unit 103′.

With reference to FIG. 3, a perspective view of a first embodiment of an exemplary hose swivel 100a is provided. The hose swivel 100a generally includes a swivel body/housing defined by a first swivel half 108a and a second swivel half 108b. The first swivel half 108a is configured to receive and/or secure a first cable 104. The second swivel half 108b is configured to receive and/or secure a second cable 105. The first cable 104 generally electrically connects the first swivel half 108a to a power source (not shown), e.g., a pool cleaner power supply or an electric outlet, and the second cable 104 generally electrically connects the second swivel half 108b to the pool cleaner unit 103. A continuous electrical contact provided between the first and second cables 104 and 105 by the first and second swivel halves 108a and 108b will be discussed in greater detail below. The first and second swivel halves 108a and 108b can be configured and dimensioned to mate with each other to create a waterproof seal therebetween. In some embodiments, the first and second swivel halves 108a and 108b include complementary threading thereon for waterproof engagement of the first and second swivel halves 108a and 108b relative to each other. The first and second cables 104 and 105 can remain axially rotatable relative to each other about a central vertical axis A₁ to assist in reducing entanglement of said cables. A skimmer outlet port 109 can be located on the first swivel half 108a for electrically connecting to and/or providing electrical power to the skimmer 101. The skimmer outlet port 109 can be at about a 90° angle relative to the vertical axis passing through the hose swivel 100a. Thus, when the hose swivel 100a is detachably secured to the skimmer 101, the skimmer outlet port 109 can electrically connect, e.g., mate, with a skimmer auxiliary inlet port (not shown) in a waterproof manner. It should be understood that rather than positioning the skimmer outlet port 109 on the first swivel half 108a, in some embodiments, the skimmer outlet port 109 can be positioned on the second swivel half 108b.

FIG. 4 illustrates a cross-sectional view of a first embodiment an exemplary hose swivel 100a. The hose swivel 100a generally includes a first cable sleeve 120 for detachably receiving and/or mating with the first cable 104. The first cable sleeve 120 can include, e.g., a grommet, a washer, a seal, and the like, for securely housing the first cable 104. A second cable sleeve 116 can detachably receive and/or mate with the second cable 105. The second cable sleeve 116 can be fabricated from, e.g., stainless steel, brass, copper, aluminum, plastic, and the like, can secure the second cable 105 and can create a sealed and/or waterproof contact to prevent entry of liquid into the hose swivel 100a. The first cable 104 generally electrically connects the first swivel half 108a to a power source (not shown), e.g., a pool cleaner power supply or an electric outlet, and the second cable 104 generally electrically connects the second swivel half 108b to the pool cleaner unit 103.

The waterproof seal between the first and second swivel halves 108a and 108b, e.g., swivel seal 113, can be achieved by, e.g., threading, adhesives, a combination of the two, or the like. For example, the first and second swivel halves 108a and 108b can include matching threading configured to mate along the surfaces of mutual contact, thereby permitting the first swivel half 108a to be fastened to the second swivel half 108b. In some embodiments, epoxy and/or silicone can be used within the hose swivel 100a to ensure a sealed and/or waterproof environment. The swivel seal 113 can be enhanced by utilization of a gasket 112, e.g., an O-ring, or the like, to further prevent leakage of fluids into the hose swivel 108a. With respect to the second cable sleeve 116, a bushing 115 and/or first and second lip seals 117a and 117b can be implemented to prevent leakage into the hose swivel 108a. The bushing 115 and first and second lip seals 117a and 117b can be configured and dimensioned to tightly fit against the outer surface of the second cable sleeve 116 after insertion of said cable into the second cable sleeve 116, while still permitting the second cable 105 and the second cable sleeve 116 to axially rotate about the central vertical axis A₁. Although not shown in FIG. 4, in some embodiments, the first cable sleeve 120 can also include, e.g., a bushing 115, first and second lip seals 117a and 117b, and the like.

The exemplary hose swivel 100a of FIG. 4 can further include an air pocket 119 to assist the hose swivel 100a in flotation. The air pocket 119 can be dimensioned differently based on the positioning of the hose swivel 100a with respect to the skimmer 101, the water line 102 and the pool cleaner unit 103. For example, when the hose swivel 100a is intended to be placed at a water line 102 position, the air pocket 119 can be greater in dimension to enhance the ability of the hose swivel 100a to float. In contrast, when the hose swivel 100a is intended to be placed below the water line 102 position, e.g., in-line, fixed to the pool cleaner unit 103, or the like, the air pocket 119 can be smaller in dimension to permit the hose swivel 100a to descend to a desired depth in a pool without complications. A uniform air pocket 119 volume can also be used for all positions of the hose swivel 100a if desired. Alternatively or in combination, the air pocket 119 can be filled with, e.g., grease, Vaseline™, and the like, to improve the waterproof seals between the first and second swivel halves 108a and 108b, and reduce the heat transfer from the electrical contact sparking at the first cable sleeve 120 and at the second cable sleeve 116.

The first swivel half 108a and the second swivel half 108b can further provide a continuous electrical contact between the first and second cables 104 and 105. In particular, the continuous electrical contact can be at least one of a vertical electrical contact assembly 110 and a horizontal electrical contact assembly 111. As discussed previously, the first and second cables 104 and 105 can be axially rotatable relative to each other. The first cable 104 can be detachably secured in a fixed position relative to the first swivel half 108a and can further be electrically connected to the vertical electrical contact assembly 110 by conduit 104a, e.g., wires, extending from the first cable 104. The second cable 105 can be detachably secured to the second swivel half 108b and can further be electrically connected to the horizontal electrical contact assembly 111. In particular, the second cable 105 can be fixedly attached to the second cable sleeve 116 and can be free to rotate within the second swivel half 108b about the central vertical axis A₁. The second cable 105 can be detachably secured to a rotating mechanism 114, e.g., a conductive cylindrical ring, disposed inside the swivel hose 100a. For example, conduit 105a, e.g., wires, extending from the second cable 105 can be soldered to an inside surface of the rotating mechanism 114 to create an electrical connection between the second cable 105 and the rotating mechanism 114. The rotating mechanism 114 can electrically connect the vertical electrical contact assembly 110, the horizontal electrical contact assembly 111 and the second cable 105. Further, the rotating mechanism 114 can rotate along a slip washer 118 about the central vertical axis A₁. The slip washer 118 can permit the rotating mechanism 114 to rotate freely relative to the second swivel half 108b to reduce entanglement and/or twisting of the first and second cables 104 and 105, while creating an additional waterproof seal in the hose swivel 100a.

In some embodiments, a first group of components, e.g., the first cable 104, conduit 104a extending from the first cable 104, the pin PCB of the vertical electrical contact assembly 110, the first cable sleeve 120, the first and second swivel halves 108a and 108b, and brush contacts positioned against the rotating mechanism 114, can be attached or fixed relative to each other. In contrast, a second group of components, e.g., the contact PCB of the vertical electrical contact assembly 110, the rotating mechanism 114, the structure supporting the contact PCB relative to the rotating mechanism 114, conduit 105a extending from the second cable 105, the second cable 105 and the second cable sleeve 116, can be attached or fixed relative to each other and can rotate relative to the first group of components about the central vertical axis A₁. Thus, when the first and/or second cable 104 and/or 105 rotates or twists during travel of the swimming pool cleaner 103, the first group of components and the second group of components can rotate relative to each other to prevent tangling of the first and/or second cables 104 and/or 105 while maintaining an electrical connection between the first and second cables 104 and 105.

Turning now to FIGS. 5A and 5B, detailed cross-sectional views of exemplary vertical and horizontal electrical contact assemblies 110 and 111, respectively, of a first embodiment of a hose swivel 100a are provided. With specific reference to FIG. 5A, the vertical electrical contact assembly 110 generally includes at least one spring-loaded pin 121, a pin printed circuit board 122 (hereinafter “pin PCB 122”) and a contact printed circuit board 123 (hereinafter “contact PCB 123”). Alternatively, the at least one spring-loaded pin 121 can be replaced with, e.g., at least one spring-loaded brush fabricated from copper graphite, and the pin PCB 122 can be replaced with a brush holder for perpendicularly holding the spring-loaded brushes against the contact PCB 123. The pin PCB 122 and the contact PCB 123 can be, e.g., printed circuit boards (“PCBs”) with matching copper trace contact circular bands located thereon. The pin PCB 122 can be configured and dimensioned to detachably secure the at least one spring-loaded pin 121 in a perpendicular orientation with respect to the planar surfaces of the pin PCB 122. Conduit 104a extending from the first cable 104 can be electrically connected to one point of the pin PCB 122. However, in some embodiments, one planar surface of the pin PCB 122 or each specific spring-loaded pin 121 can be electrically connected, e.g., soldered, to specific conduit 104a or wiring, e.g., a 16 AWG wire, of the first cable 104 at a copper trace contact located on the pin PCB 122. It should be understood that a plurality of wires can be implemented for connecting to the first cable 104. For each of the plurality of wires, a separate copper trace contact of the pin PCB 122 can be utilized. An opposite planar surface of the pin PCB 122 can be configured to receive at least a first spring-loaded pin 121. In particular, the spring-loaded pin also contacts the copper trace contact located on the pin PCB 122, thereby electrically connecting the conduit 104a of the first cable 104 to a dedicated spring-loaded pin 121. It should be understood that a specific conduit 104a can be implemented in conjunction with a dedicated copper trace contact and spring-loaded pin 121. A distal end of the spring-loaded pins 121 relative to the pin PCB 122 can be positioned so as to continuously contact a matching copper trace contact of the contact PCB 123. Thus, each of the spring-loaded pins 121 utilized can contact a separate copper trace contact on the contact PCB 123 to maintain an electrical connection. The vertical electrical contact assembly 110 further includes a connector 124 which can be electrically wired to connect the appropriate copper trace contacts of the contact PCB 123 to the rotating mechanism 114. The rotating mechanism 114 can in turn connect the appropriate copper trace contacts to the horizontal electrical contact assembly 111.

With reference to FIG. 5B, a detailed view of the horizontal electrical contact assembly 111 is provided. In particular, the horizontal electrical contact assembly 111 can be a slip ring assembly, e.g., a contact ring 125 and at least one brush 126 (see, e.g., SRC Pin Connection Slip Ring, SRC 032 Series, Hangzhou Prosper Mechanical & Electrical Technology Co., Ltd., (2011)). The contact ring 125 can be fabricated from, e.g., brass, or the like. The at least one brush 126 can include a pair of brushes 126 and can be fabricated from, e.g., a self-lubricating carbon graphite, copper graphite, silver graphite or the like. The contact ring 125 can be secured and/or connected to the rotating mechanism 114 such that the rotating mechanism 114 and the contact ring 125 can concurrently axially rotate with the second cable 105 about the central vertical axis A₁. The conduit 105a extending from the second cable 105 can be soldered to an inside surface of the rotating mechanism 114. In addition, the connector 124 can fixedly and electrically connect the contact PCB 123 to the rotating mechanism 114, thereby permitting the contact PCB 123 to rotate with the second cable 105, while maintaining a continuous electrical connection between the first and second cables 104 and 105. Thus, the second cable 105 and the rotating mechanism 114 can freely rotate to prevent entanglement and/or twisting of the first and second cables 104 and 105, while the first cable 104 connected to the first swivel half 108 can remain fixedly positioned relative to the second cable 105. For example, the second cable 105 and the rotating mechanism 114 can rotate relative to the first cable 104 and the first cable sleeve 120.

In particular and as discussed above, a first group of components, e.g., the first cable 104, conduit 104a extending from the first cable 104, the pin PCB 122, the first cable sleeve 120, the first and second swivel halves 108a and 108b, and brushes 126, can be attached or fixed relative to each other. In contrast, a second group of components, e.g., the contact PCB 123, the rotating mechanism 114, the connector 124, conduit 105a extending from the second cable 105, the second cable 105 and the second cable sleeve 116, can be attached or fixed relative to each other and can rotate relative to the first group of components about the central vertical axis A₁. Thus, when the first and/or second cable 104 and/or 105 rotates or twists during travel of the swimming pool cleaner 103, the first group of components and the second group of components can rotate relative to each other to prevent tangling of the first and/or second cables 104 and/or 105. In some embodiments, the at least one brush 126 can be spring-loaded, such that a sufficiently strong surface-to-surface contact exists and is maintained between the at least one brush 126 and the contact ring 125. For example, the at least one brush 126 can be attached to spring-loaded brush arms (not shown) which can provide a constant compressive force by the at least one brush 126 against the contact ring 125.

FIGS. 6A and 6B provide detailed views of a first embodiment of exemplary spring-loaded pins 121 implemented in conjunction with an exemplary vertical electrical contact assembly 110. In particular, the exemplary spring-loaded pins 121 generally include a pin piston 127, a pin body 128 and a pin spring 129 for actuating the pin piston 127 along a central vertical axis A₂ against a copper trace contact of the contact PCB 123. The pin piston 127 can be fabricated from a soft metal, e.g., copper graphite, or the like, while the remaining components of the spring-loaded pin 121 can be fabricated from, e.g., stainless steel, brass alloy, or the like. The spring-loaded pin 121 can include a plating of, e.g., gold over nickel. Alternatively, the pin piston 127 can be a spring-loaded brush fabricated from, e.g., copper graphite. The spring-loaded pin 121 can also include a pin flange 130 and an optional pin male element 131.

Pins that are not spring-loaded can result in pitting, e.g., cavities, wearing, or the like, of the copper trace contact surface, as well as corrosion, e.g., wearing and/or deterioration, of the pins themselves. The pitting and/or corrosion further damages and/or eliminates the electrical surface-to-surface contact between the pin and the copper trace contact due to the uneven copper trace contact surface and/or the insufficient length of the pin to contact the copper trace contact. In direct contrast, the exemplary spring-loaded pins 121 of the present disclosure incorporate a biasing pin spring 129 for maintaining surface-to-surface contact between the pin piston 127 and the copper trace contact surface. In particular, the pin spring 129 can regulate the force with which the pin piston 127 presses against the copper trace contact and can adjust the length of the pin piston 127 protrusion out of the pin body 128. The pin piston 127 can be fabricated from and/or include a shell plating of the same material type and/or durability as the copper trace contact surface, e.g., copper graphite, copper alloy, or the like. The contact plating can be, e.g., 10 μ gold over nickel, while the shell plating can be, e.g., 20 μ gold over nickel (see, e.g., Mill-Max Mfg. Corp., Power Spring Pin, Part No. 0850-0-XX-20-83-14-11-0 (2012)). Thus, if wearing of materials occurs, the pin piston 127 can wear evenly while the copper trace contact surface remains unharmed. However, rather than losing surface-to-surface contact between the spring-loaded pin 121 and the copper trace contact, as the pin piston 127 gradually wears, the pin spring 129 can compensate for the reduction in pin piston 127 length and can force the pin piston 127 to protrude further out of the pin body 128 to sufficiently contact the copper trace contact.

The pin piston 127 can be positioned in three settings relative to the pin body 128, e.g., at a minimum stroke, a medium stroke and a maximum stroke. The minimum stroke generally refers to the pin piston 127 protruding the farthest from the pin body 128 along the central vertical axis A₂ and/or compressing the pin spring 129 against the copper trace contact the least, thus delivering the least force against the copper trace contact. The medium stroke generally refers to the pin piston 127 protruding from the pin body 128 an intermediate distance along the central vertical axis A₂ and/or partially compressing the pin spring 129, thus delivering a medium force, e.g., about 120 grams, against the copper trace contact. The maximum stroke generally refers to the pin piston 127 protruding the least from the pin body 128 along the central vertical axis A₂ and/or compressing the pin spring 129 the most, thus delivering the most force for electrical contact and spinning friction against the copper trace contact. Operation in the medium stroke range is generally desired for low current draw applications and the spring force maintains continuous electrical contact. In some embodiments, the minimum stroke force range can produce unpredictable results and the maximum stroke force can over-compress and/or damage the pin spring 129 and/or the copper trace contact. Thus, it should be understood that by implementing the spring-loaded pin 121 in a medium stroke position, a continuous electrical surface-to-surface contact can be maintained between the spring-loaded pin 121 and the copper trace contact surface of the contact PCB 123.

FIGS. 7A and 7B provide detailed views of a first embodiment of an exemplary vertical electrical contact assembly 110. With reference to the pin PCB 122, a plurality of mounting holes 132a can be provided for securely mounting the pin PCB 122 to the first swivel half 108a. The mounting holes 132a can be dimensioned to permit appropriate mounting of the pin PCB 122, e.g., about a 0.15 inch diameter. It should be understood that the dimensions discussed herein are merely exemplary and that alternative dimensions can be utilized. The pin PCB 122 generally includes a plurality of copper trace contacts 134a and a plurality of trace gaps 133a separating the plurality of copper trace contacts 134a. Each copper trace contact 134a can further include a wire soldering hole 137a and a pin hole 136. The wire soldering hole 137a can be implemented in conjunction with a first cable wire 135a, e.g., a 16 AWG wire, any electrical conduit, and the like, extending from the first cable 104. The exposed end of the first cable wire 135a can be passed through the wire soldering hole 137a and can be, e.g., soldered, to the copper trace contact 134a.

Similarly to the attachment of the first cable wire 135a through the wire soldering hole 137a, the pin male element 131 of the spring-loaded pin 121 can be securely mated with and/or inserted into the appropriate pin hole 136 located on the pin PCB 122. In other embodiments, spring-loaded brushes can be implemented. The pin flange 130 can act as a “stop” to control the depth the pin male element 131 passing through the pin hole 136 and can further act to stabilize the spring-loaded pin 121 against the planar surface of the pin PCB 122. Alternatively, the pin flange 130 of the spring-loaded pin 121 can be connected, e.g., soldered, directly to the copper trace contact 134a without implementation of the pin male element 131. The pin male element 131 and the pin hole 136 can be configured and dimensioned to ensure a secure electrical contact between the spring-loaded pin 121 and the copper trace contact 134a. In addition, the pin male element 131 can be, e.g., soldered, to the copper trace contact 134a to enhance the electrical contact between said elements. As discussed previously and as shown in greater detail in FIGS. 6A, 6B and 7B, the pin spring 129 can maintain a continuous electrical surface-to-surface contact between the pin piston 127 and a dedicated copper trace contact 134b located on the contact PCB 123.

With respect to the contact PCB 123 depicted in FIG. 7A, similar electrical connections can be established between a plurality of second cable wires 135b, e.g., any electrical conduit, and the dedicated copper trace contacts 134b. In particular, the exposed end of the second cable wire 135b can be inserted through the appropriate wire soldering hole 137b and can further be electrically connected, e.g., soldered, to ensure a strong electrical contact. It should be understood that the spring-loaded pin 121 connected to a copper trace contact 134a maintains an electrical surface-to-surface contact with a matching copper trace contact 134b. Thus, a continuous electrical connection can be maintained between the first cable wire 135a and the second cable wire 135b during rotation of the second cable 105 and/or the contact PCB 123. For example, during rotation of the second cable 105, the contact PCB 123 can simultaneously rotate about a central vertical axis A₃ relative to the pin PCB 122.

Turning now to FIGS. 8A and 8B, perspective views of a second embodiment of an exemplary hose swivel 200 are provided. Unless stated otherwise, it should be understood that the components of the exemplary hose swivel 200 function similarly to the components previously discussed with respect to the exemplary hose swivel 100a. The hose swivel 200 can be positioned at three locations, e.g., attached to a skimmer 101, in-line, attached to a pool cleaner unit 103, or the like, similar to the exemplary hose swivels 100a, 100b and 100c. The hose swivel 200 generally includes a hose swivel 200 body and/or housing, e.g., the first swivel half 201a and the second swivel half 201b. The first swivel half 201a can include a first cable sleeve 202a for receiving a first cable (not shown), e.g., a cable leading to a power source. The second swivel half 201b can include a second cable sleeve 202b for receiving a second cable 203, e.g., a cable leading to a pool cleaner unit 103. The second swivel half 201b can further include a swivel flange 204. As will be discussed in greater detail below, when the hose swivel 200 is detachably secured to a skimmer 101, the swivel flange 204 can support and/or prevent the hose swivel 200 from detaching from the skimmer 101 and/or translating along a central vertical axis A₄ lower into the water due to downward pulling on the second cable 203 by the pool cleaner unit 103 as it moves along the swimming pool floor and/or walls.

Turning to FIG. 9, the first and second swivel halves 201a and 201b of a second embodiment of the hose swivel 200 of FIGS. 8A and 8B are provided. In particular, the first and second swivel halves 201a and 201b can be detachably secured relative to each other with a waterproof seal, e.g., swivel seal 206, which can be achieved by, e.g., threading, adhesives, a combination of the two, or the like. For example, the first and second swivel halves 201a and 201b can include matching threading configured to mate along the surfaces of mutual contact, thereby permitting the first swivel half 201a to be fastened to the second swivel half 201b. Although not illustrated, the waterproof seal can be further enhanced by use of a gasket, e.g., an O-ring, at the top of the threaded swivel seal 206. In some embodiments, epoxy and/or silicone can be introduced into the first and second swivel halves 201a and 201b to enhance the waterproof seal. The first cable sleeve 202a can include a bore 205, e.g., a female receptacle, for receiving a first cable. In some embodiments, the bore 205 can be a threaded bore (not shown). In embodiments where the bore 205 is a threaded bore, the first cable can include, e.g., a collar with matching threading on one end which is geometrically configured to mate with the threaded bore (not shown). Thus, the first cable can be detachably secured to the first cable sleeve 202a in a waterproof manner. The first cable can thereby electrically connect the first swivel half 201a to a power source (not shown), e.g., a pool cleaner power supply or an electric outlet.

The second cable sleeve 202b can be configured similarly to the second cable sleeve 116 discussed previously. Thus, the second cable sleeve 202b can include first and second slip seals 213a and 213b and a bushing 212. Rather than a bushing 212, a bearing can optionally be used. A steel sleeve 211 can be positioned within the second cable sleeve 202b to create a sealed contact between the second cable sleeve 202b and the second cable 203. The second cable can thereby electrically connect the second cable half 201b to the pool cleaner unit 103. The first and second cable 203 can thus be detached from the relative sleeves when desired to position the hose swivel 200 in the desired location, e.g., on the skimmer 101, in-line, attached to the pool cleaner unit 103, or the like. Alternatively, the exemplary hose swivel 200 can permit only one of the cables to be detached from the hose swivel 200 while the other cable remains attached. The steel sleeve 211, e.g., a tube, can be fabricated from, e.g., stainless steel, brass, copper, aluminum, plastic, and the like. The hose swivel 200 can further include a lock pin 210, which can be fabricated from, e.g., stainless steel, and an air pocket 209 for enhancing the floatability and/or buoyancy of the hose swivel 200. The lock pin 210 can maintain a fixed relation between the steel sleeve 211 and the contact PCB holder 214 to ensure the second cable 203 and the contact PCB 208 rotate in unison along the central vertical axis A₄. In other embodiments, rather than a lock pin 210, e.g., overmold/glue, a thread-lock, and the like, can be implemented to “join” the steel sleeve 211 and the contact PCB holder 214 to create a single movement unit.

To facilitate rotation relative to each other, a first group of components, e.g., the first cable, conduit extending from the first cable 104, the pin PCB 207, the first cable sleeve 202a, the first and second swivel halves 201a and 201b, electrical pins 232, and spring-loaded pins 217, can be attached or fixed relative to each other. In contrast, a second group of components, e.g., the contact PCB 208, the contact PCB holder 214, the steel sleeve 211, the lock pin 210, conduit extending from the second cable, and the second cable 105, can be attached or fixed relative to each other and can rotate relative to the first group of components along the central vertical axis A₄. Thus, when the first and/or second cable rotates or twists during travel of the swimming pool cleaner 103, the first group of components and the second group of components can rotate relative to each other to prevent tangling of the first and/or second cables.

The vertical electrical contact assembly 216 of the hose swivel 200 is similar to the assembly discussed previously. In general, the vertical electrical contact assembly 216 can include a pin PCB 207, e.g., a PCB for supporting and/or housing spring-loaded pins 217, and a contact PCB 208. In other embodiments, rather than the spring-loaded pins 217, spring-loaded brushes can be implemented. The pin PCB 207 can be detachably secured with, e.g., screws, to a pin PCB holder 215 formed as an internal extension of the first swivel half 201a. The contact PCB 208 can be detachably secured with, e.g., screws, to a contact PCB holder 214, which can permit the contact PCB 208, the contact PCB holder 214 and the steel sleeve 211 to axially rotate based on the rotation of the second cable 203. Electrical connectors 231, e.g., Y-connectors, can connect conduit (not shown) extending from the first cable 104 to the spring-loaded pins 217 via electrical pins 232 fixated in the non-conductive body of the hose swivel 200. Conduit (not shown) extending from the second cable 105 can be electrically connected, e.g., soldered, to the traces located on the bottom of the contact PCB 208. In some exemplary embodiments, the hose swivel 200 can include a skimmer outlet port and the electrical connectors 231 can electrically connect to the skimmer outlet port to provide power to a skimmer 101 (not shown).

FIGS. 10A-C show detailed views of the pin PCB 207 of a second embodiment of a vertical electrical contact assembly 216 of an exemplary hose swivel 200. The pin PCB 207 can include a plurality of mounting holes 218 for securing the pin PCB 207 to the pin PCB holder 215. A plurality of pin holes 220 can further be provided for receiving a pin male element 224 of a spring-loaded pin 217. In particular, the exemplary spring-loaded pin 217 can include a pin piston 221, a pin body 222, a pin flange 223, a pin male element 224 and an internal spring (not shown) for axially actuating the pin piston 221. Thus, the pin male element 224 can be inserted into the appropriate pin hole 220 from one side of the pin PCB 207 and can be further secured on the opposite side of the pin PCB 207 with a pin fastener 219. The pin flange 223 can limit the depth of insertion of the spring-loaded pin 217 into the pin hole 220 and can further stabilize and/or position the spring-loaded pin 217 in a perpendicular position relative to a planar surface of the pin PCB 207. The pin piston 221 can be manufactured from, e.g., brass, or can be replaced with a spring-loaded brush contact, e.g., a copper graphite block and/or brush. Due to the internal spring of the spring-loaded pin 217, a vertical surface-to-surface contact can be continuously maintained against a copper trace contact of the contact PCB 208. It should be understood that similar to the vertical electrical contact assembly 110, wires extending from a first cable (not shown) can be electrically connected, e.g., soldered, to the exposed end of the pin male element 224 which is fixed to the pin fastener 219.

With reference to FIGS. 11A and 11B, an exemplary contact PCB 208 of a second embodiment of an exemplary vertical electrical contact assembly 216 of a hose swivel 200 is provided. The contact PCB 208 generally includes mounting holes 225 for securing the contact PCB 208 to the contact PCB holder 214. This attachment ensures a simultaneous axial rotation of the contact PCB 208 with the contact PCB holder 214 during rotation of the second cable 203, thereby preventing entanglement and/or twisting of the first cable and second cable 203. The contact PCB 208 generally also includes a plurality of cylindrically shaped copper trace contact 226 bands and trace gaps 227 separating the copper trace contacts 226. The contact PCB 208 can be secured to the contact PCB holder 214 such that the surface having the copper trace contacts 226 perpendicularly faces the spring-loaded pins 217 and is parallel to the planar surface of the pin PCB 207. It should be understood that each copper trace contact 226 can be dedicated specifically to a single spring-loaded pin 217 of the pin PCB 207. With specific reference to FIG. 11B, the contact PCB 208 can further include soldering blocks 228 for electrically connecting, e.g., soldering, wires extending from the second cable 203 (not shown) to the copper trace contacts 226. Each soldering block 228 can be electrically wired through the body of the contact PCB 208 to a dedicated copper trace contact 226. Thus, a continuous electrical contact can exist between the first cable and the second cable 203 during rotation of the contact PCB 208.

FIG. 12 illustrates a cross-sectional view of the first swivel half 201a of a second embodiment of a hose swivel 200 and, in particular, a partial view of the pin PCB 207 as described above. The pin PCB 207 can be securely mounted to the pin PCB holder 215 through the mounting holes 218. The pin PCB 207 can further support a plurality of spring-loaded pins 217 in a perpendicular position relative to the planar surface of the pin PCB 207. The spring-loaded pins 217 can thereby perpendicularly contact the contact PCB 208 of the second swivel half 201b as the contact PCB 208 rotates about the central vertical axis A₄. An electrical connection between the pin PCB 207 and conduit, e.g., wires, extending from the first cable 104 (not shown) can be made via electrical pins 232 fixated in the non-conductive body of the first swivel half 201a. The swivel seal 206 can consist of first swivel seal threads 206a located on a flange of the first swivel half 201 a and second swivel seal threads 206b located on a mating surface of the second swivel half 201b.

With reference to FIGS. 13A and 13B, the second swivel half 201b and the contact PCB holder 214 of a second embodiment of a hose swivel 200 are provided. The cross-sectional view of the second swivel half 201b illustrates the second swivel seal threads 206b which are configured to mate with the first swivel seal threads 206a of the first swivel half 201a to create the swivel seal 206. The contact PCB 208 can be attached to the contact PCB holder 214 through mounting holes 225. With specific reference to FIG. 13B, the contact PCB holder 214 can include attachment holes 229 for receiving, e.g., a screw, for fastening of the contact PCB 208 thereon. Although not shown, it should be understood that the pin PCB holder 215 can have similar mounting holes 229 for mounting the pin PCB 207. The second swivel half 201b can further include a lock pin 210, which can be fabricated from, e.g., stainless steel, fixated within a U-channel groove 230 in the walls of the contact PCB holder 214. Thus, when inserted inside the U-channel groove 230, the lock pin 210 can maintain a fixed relation between the steel sleeve 211 and the contact PCB holder 214 to ensure the second cable 203 and the contact PCB 208 rotate in unison about the central vertical axis A₄. Conduit, e.g., wires, extending from the second cable 203 can be electrically connected, e.g., soldered, to the copper trace contacts 226 on the bottom of the contact PCB 208 to maintain an electrical connection between the second cable 203 and the contact PCB 208. In some embodiments, the contact PCB 208, the contact PCB holder 214, the locking pin 210, the steel sleeve 211, the second cable 203, and conduit extending from the second cable can be fixed or attached relative to each other and can rotate relative to the second swivel half 201b.

Turning to FIG. 14, a detailed view of the vertical electrical contact assembly 216 of a second embodiment of a hose swivel 200 is provided, generally including the pin PCB 207 and the contact PCB 208. As described previously, the perpendicularly positioned spring-loaded pins 217 extend down from the pin PCB 207 in a direction parallel to the central vertical axis A₄ and create a surface-to-surface electrical contact with the copper trace contacts 226. Each spring-loaded pin 217 is generally dedicated to a specific copper trace contact 226. As the contact PCB holder 214 axially rotates concurrently with the second cable 203, the contact PCB 208 axially rotate in unison about the central vertical axis A₄. The spring-loaded pin 217 thus follows the circular “track” of the copper trace contact 226 and maintains the surface-to-surface contact to produce the electrical connection between the pin PCB 207 and the contact PCB 208. Although not illustrated in FIG. 14, it should be understood that conduit extending from the first cable, e.g., a plurality of first cable wires 135a (see, e.g., FIG. 7A), can electrically connect to the spring-loaded pins 217 and conduit extending from the second cable, e.g., a plurality of second cable wires 135b (see, e.g., FIG. 7A), can electrically connect to the soldering blocks 228 of the contact PCB 208. In particular, the plurality of first cable wires 135a can electrically connect to the spring-loaded pins 217 via electrical pins 232 fixated within the non-conductive body of the hose swivel 200 and electrical connectors 231. The first cable can further electrically connect the hose swivel 200 to a power source (not shown), e.g., a pool cleaner power supply or an electric outlet, and the second cable can electrically connect the hose swivel 200 to the pool cleaner unit 103. A continuous electrical connection can thereby be maintained between the first cable and a second cable, while still permitting the second cable to axially rotate freely about the central vertical axis A₄ to prevent entanglement and/or twisting of the first and second cables 104 and 105 during movement of the pool cleaner unit 103 along the swimming pool floor and/or walls.

FIGS. 15A-C illustrate a first embodiment of exemplary spring-loaded brushes 300 to be implemented as an alternative to and/or in combination with the spring-loaded pins 121, 217 previously discussed with respect to exemplary hose swivels 100a and 200. The exemplary spring-loaded brushes 300 generally include a spring arm 301, a plurality of mounting holes 302, a pair of brush attachment brackets 303 and a pair of brushes 304. The spring arm 301 can be configured to provide a constant inwardly directed force on the pair of brushes 304, e.g., pushing the pair of brushes 304 toward each other. The plurality of mounting holes 302 can be utilized for mounting the spring-loaded brush 300 to a surrounding structure located within an exemplary hose swivel. In some embodiments, conduit extending from a first cable, e.g., a cable leading to a power source (not shown), can be soldered to at least a portion of the spring arm 301. The spring arm 301 and the pair of brush attachment brackets 303 can be fabricated from, e.g., stainless steel. The pair of brush attachment brackets 303 can be configured to securely fasten and/or clamp the pair of brushes 304 in an opposing relation relative to each other. The pair of brushes 304 can be, e.g., concavely shaped, to provide an enhanced surface-to-surface contact against a rotating ring member positioned between the pair of brushes 304. For example, the inner surface of the brushes 304 can be configured complementary to an outer surface of a rotating ring member against which the brushes 304 press, thereby allowing the brushes 304 to mate against the outer surface of the rotating ring member. However, alternative configurations of the pair of brushes 304 can be implemented. In addition, the pair of brushes 304 can be fabricated from, e.g., carbon graphite blocks, or the like, and the rotating ring member can be fabricated from, e.g., brass, or the like.

With reference to FIG. 16, a third embodiment of an exemplary hose swivel 400 is illustrated in conjunction with the exemplary spring-loaded brushes 300. It should be understood that the exemplary spring-loaded brushes 300 can be implemented in the previously discusses hose swivel 100a and 200 housings and, in particular, can be implemented as a first embodiment of an exemplary horizontal electrical contact assembly 111. The plurality of spring-loaded brushes 300 can maintain a continuous surface-to-surface contact with a rotating ring member 401. As would be understood by those of skill in the art, the spring-loaded brushes 300 implemented in conjunction with the rotating ring member 401 can be similar to a slip ring configuration. The spring-loaded brushes 300 can be fastened to an attachment member 402 of the hose swivel 400. A first cable (not shown) can be electrically connected, e.g., soldered, to the spring arm 301 of the spring-loaded brushes 300 and the second cable 403 can be electrically connected, e.g., soldered, to the rotating ring member 401. Although not illustrated in FIG. 16, it should be understood that the first cable can electrically connect the hose swivel 400 to a power source, e.g., a pool cleaner power supply or an electric outlet, and the second cable can electrically connect the hose swivel 400 to the pool cleaner unit 103. The second cable 403 can detachably secure to the hose swivel 400 with, e.g., the attachment collar 404, and can rotate concurrently with the rotating ring member 401 about a central vertical axis A₅ to prevent entanglement and/or twisting of the first cable and second cable 403 during movement of the pool cleaner unit 103 on the swimming pool floor and/or walls. Thus, a continuous electrical connection can be maintained between the first cable and second cable 403, while preventing entanglement of said cables.

As an alternative and/or in combination with the exemplary electrical contacts discussed herein, FIG. 17 provides a second embodiment of an exemplary horizontal electrical contact assembly 500. In particular, the horizontal electrical contact assembly 500 generally includes a mounting plate 501, a plurality of brush chambers 502, a rotating ring member 503 and a plurality of brushes 505. The mounting plate 501 can be, e.g., a washer-shaped member upon which a plurality of brush chambers 502 can be mounted. The brush chambers 502 can be securely mounted on the mounting plate 505 and can further receive brushes 505. The brush chambers 502 can internally contain a spring-loaded mechanism (not shown) to provide an adjustment of the protrusion distance of the brushes 505 with respect to the brush chambers 502 and further to regulate the force applied by the brushes 505 on the rotating ring member 503. As the brushes 505 evenly wear due to the pressure against the rotating ring member 503, the spring-loaded mechanism can adjust the projection distance of the brushes 505 out of the brush chambers 502 to maintain a continuous surface-to-surface contact between the brushes 505 and the rotating ring member 503.

The brushes 505 can be fabricated from, e.g., copper graphite blocks, carbon graphite blocks, silver graphite blocks, and the like, and can define a concave contact surface to enhance the surface-to-surface contact against the rotating ring member 503. The material of fabrication can create a surface-to-surface contact with a rotating ring member 503 which generally produces low friction due to the self-lubricating characteristic of copper graphite. The rotating ring member 503 can be fabricated from, e.g., brass, or the like, and can include an inner surface which can be electrically connected, e.g., soldered, to wires 504 extending from a second cable. The brush chambers 502 can be electrically connected, e.g., soldered, to wires leading to a first cable which can in turn lead to a power source (not shown), e.g., a pool cleaner power supply or an electric outlet. The horizontal electrical contact assembly 500 can be secured within an exemplary hose swivel, e.g., between the exemplary first and second halves of the hose swivel described herein. Thus, the rotating ring member 503 can rotate concurrently with a second cable leading to the pool cleaner unit 103 about a central vertical axis A₆ to prevent entanglement of the second cable as the pool cleaner unit 103 travels across the swimming pool floor and/or walls, while maintaining an electrical connection between the second cable and the first cable. Although illustrated as being dimensioned to simultaneously contact only three brushes 505, it should be understood that the dimensions, e.g., height, of the rotating ring member 503 can be increased to permit a plurality of mounting plates 501 and brushes 505 to be utilized.

Turning now to FIG. 18, an exemplary horizontal electrical contact assembly 600 is provided implementing the spring-loaded brushes 300 and the first and second embodiments of the horizontal electrical contact assemblies 400 and 500 in combination. In particular, a rotating ring member 503 can be implemented for maintaining a surface-to-surface contact with the plurality of spring-loaded brushes 300 and brushes 500. As can be seen from FIG. 18, a plurality of mounting plates 505 can be used to increase the number of brushes 505 which can be implemented with the horizontal electrical contact assembly 600. Although illustrating three brushes 505 attached to each mounting plate 505, it should be understood that a greater and/or lesser number of brushes 505 can be utilized. The rotating ring member 503 can include non-conductive ring member dividers 602 along the circumference of the rotating ring member 503 to, e.g., prevent two spring-loaded brushes 300 from coming into contact with each other. A support 601 can be used to secure both the spring arm 301 of the spring-loaded brushes 300, as well as the mounting plates 501. A first cable leading to a power source (not shown), e.g., a pool cleaner power supply or an electric outlet, can be electrically connected, e.g., soldered, to the plurality of spring-loaded brushes 300 and brushes 505 via conduit extending from the first cable, while a second cable leading to a pool cleaner unit 103 can be electrically connected, e.g., soldered, to an inner surface of the rotating ring member 503 via conduit extending form the second cable. The horizontal electrical contact assembly 600 can be secured within an exemplary hose swivel, e.g., between the exemplary first and second halves of the hose swivel described herein. Thus, a continuous electrical contact can be maintained between the first and second cables as the pool cleaner unit 103 moves along the pool floor and/or walls and the rotating ring member 503 rotates about a central vertical axis A₇.

With reference to FIG. 19, a cross-sectional view of a fourth embodiment of an exemplary hose swivel 700 housing for positioning at a water line 102 is provided which can incorporate at least one of a vertical electrical contact assembly and/or a horizontal electrical contact assembly. The hose swivel 700 generally includes a first swivel half 701a and a second swivel half 701b fastened together at a waterproof swivel seal 708. The swivel seal 708 can include, e.g., mating threads on the first and second swivel halves 701a and 701b, adhesives, O-rings, or the like, to ensure a waterproof seal. An electrical assembly support 702 can support at least one of a vertical electrical contact assembly and/or a horizontal electrical contact assembly. A first cable (not shown) can be detachably secured to the hose swivel 700 through a first cable collar 707 and can further be electrically wired to at least one of a vertical electrical contact assembly and/or a horizontal electrical contact assembly that can be positioned in the internal cavity 209 of the hose swivel 700 housing. For example, the first swivel half 701a can include a first cable sleeve (not shown) similar to the first cable sleeve 804 of FIG. 22 to interconnect the first cable to the vertical electrical contact assembly and/or the horizontal electrical contact assembly. A second cable (not shown) can be detachably secured to the hose swivel 700 through a second cable sleeve 703 capable of axial rotation. A waterproof seal between the second swivel half 701b and the second cable sleeve 703 can be created with, e.g., a bushing 704, first and second lip seals 705a and 705, and the like. The second cable can be inserted into the second cable sleeve 703 and can further be electrically wired to at least one of a vertical electrical contact assembly and/or a horizontal electrical contact assembly (not shown). Thus, a continuous electrical contact between the first cable and the second cable can be maintained while the second cable axially rotates about a central vertical axis A₈ to reduce entanglement and/or twisting of said cables. As discussed above, the first cable can electrically connect the hose swivel 700 to a power source (not shown), e.g., a pool cleaner power supply or an electric outlet, and the second cable can electrically connect the hose swivel 700 to the pool cleaner unit 103. The hose swivel 700 can optionally include a supplemental component 706, e.g., a light, a power outlet, or the like, located inside a translucent cover at a top portion of the first swivel half 701a. The cavity 709, in addition to receiving the electrical contact assembly, can form an air pocket for enhancing the flotation of the hose swivel 700 at the water line.

FIG. 20A shows the implementation of a fourth embodiment of a hose swivel 700 in conjunction with a vertical electrical contact assembly 715. The vertical electrical contact assembly 715 can function similarly to the vertical electrical contact assembly 216 of FIG. 9. However, as an alternate to a pin PCB 207, the exemplary vertical electrical contact assembly 715 can include a brush holder 712 for maintaining the plurality of brushes 711 in a perpendicular position relative to the contact PCB 710. In particular, the brush holder 712 can position the plurality of brushes 711 parallel to the central vertical axis A₈. The brush holder 712 can be, e.g., spring-loaded, to maintain a continuous surface-to-surface contact between the brushes 711 and the contact PCB 710. Conduit 730a, e.g., wires, extending from a first cable can be electrically connected to the brushes 711 through apertures formed along the top surface of the brush holder 712. For example, conduit 730a can be soldered to conductive components connected to the brushes 711. Further, the brushes 711 can be fabricated from, e.g., carbon graphite, copper graphite, silver graphite, and the like, to ensure a low friction, self-lubricating and evenly wearing material. In particular, the soft material of fabrication of the brushes 711 permits the brushes 711 to slowly and/or evenly wear over time, while maintaining a undamaged surface of the contact PCB 710.

The contact PCB 710 can be supported by the electrical assembly support 702 and can be further secured to the second cable sleeve 703 to permit the two components to axially rotate in unison about the central vertical axis A₈. The contact PCB 710 can also include a plurality of copper trace contacts 714 and trace gaps 713 in between the copper trace contacts 714 to separate the electrical paths. The copper trace contacts 714 can be in a continuous surface-to-surface contact with the brushes 711. Conduit 730b extending from the second cable can be soldered to the copper trace contacts 714 on the bottom of the contact PCB 710 to create an electrical connection between the second cable and the contact PCB 710. Thus, when the second cable inserted into the second cable sleeve 703 rotates about the central vertical axis A₈, the contact PCB 710 can simultaneously rotate about the central vertical axis A₈ while maintaining an electrical contact with the brushes 711.

In particular, to facilitate rotation relative to each other, a first group of components, e.g., the first cable, conduit 730a extending from the first cable, the brushes 711, the brush holder 712, the first cable collar 707, and the first swivel half 701a, can be attached or fixed relative to each other. In contrast, a second group of components, e.g., the contact PCB 710, the second cable sleeve 703, conduit 730b extending from the second cable, and the second cable, can be attached or fixed relative to each other and can rotate relative to the first group of components about the central vertical axis A₈. Thus, when the first and/or second cable rotates or twists during travel of the swimming pool cleaner 103, the first group of components and the second group of components can rotate relative to each other to prevent tangling of the first and/or second cables.

FIGS. 20B-E illustrate detailed views of exemplary spring-loaded brushes 711. The exemplary spring-loaded brushes 711 include a mounting cap 717, a spring 718 and a contact block 719. The mounting cap 717 can securely connect to the spring 718 and can further detachably secure to a brush holder 712 for fixating the spring-loaded brushes 711 in the desired orientation. In some embodiments, a position of the mounting cap 717 along a vertical rod 723 can be varied to increase or decrease the force imparted by the spring 718 against the contact block 719. For example, positioning the mounting cap 717 farther from the contact block 719 along the vertical rod 723 can reduce the force imparted by the spring 718 against the contact block 719 due to the reduced compression of the spring 718. Similarly, positioning the mounting cap 717 closer to the contact block 719 along the vertical rod 723 can increase the force imparted by the spring 718 against the contact block 719 due to the increased compression of the spring 718. The force imparted by the spring-loaded brushes 711 against a rotating contact ring 722 (see, e.g., FIG. 20E) can thereby be adjusted. The spring 718 can connect the mounting cap 717 to the contact block 719. The spring 718 can be selected such that a continuous surface-to-surface electrical contact is created as the contact block 719 evenly wears during operation. As previously discussed, the mounting block 719 can be fabricated from, e.g., copper graphite, carbon graphite, silver graphite, and the like.

With specific reference to FIG. 20E, the spring-loaded brushes 711 can be oriented in a configuration similar to that illustrated in FIG. 17. In particular, the spring-loaded brushes 711 can be mounted within brush chambers 720 and can be detachably secured using brush pins 721. In some embodiments, adjusting a position of the brush pin 721 along a chamber slot 724 can function to adjust the force imparted by the contact block 719 against a rotating contact ring 722 by regulating the amount of compression in the spring 718. The spring-loaded brushes 711 can further be oriented such that continuous surface-to-surface electrical contact is maintained against a rotating contact ring 722 fabricated from, e.g., brass, or the like.

FIG. 21 illustrates a fourth embodiment of an exemplary hose swivel 700 in conjunction with a horizontal electrical contact assembly 716 shown diagrammatically (internal components not shown), e.g., a slip ring (see, e.g., SRC Pin Connection Slip Ring, SRC 032 Series, Hangzhou Prosper Mechanical & Electrical Technology Co., Ltd., (2011)). In particular, the horizontal electrical contact assembly 716 includes a central body 731, a first extension 732a rotatably attached relative to the central body 731, and a second extension 732b rotatably attached relative to the central body 731. The first and second extensions 732a and 732b can thereby rotate with respect to the central body 731 about the central vertical axis A₈ while maintaining an electrical connection between the first and second extensions 732a and 732b and the central body 731. Each of the first and second extensions 732a and 732b also includes electrical pins extending therefrom in a direction parallel to the central vertical axis A₈, e.g., two conductive pins, which can be used to electrically connect to the first and second cables. For example, conduit 730a extending from the first cable can be electrically connected to the electrical pins extending from the first extension 732a and conduit 730b extending from the second cable can be electrically connected to the electrical pins extending from the second extension 732b. Thus, when either the first and/or second cable rotates axially, the first and/or second extensions 732a and/or 732b can rotate relative to the central body 731 about the central vertical axis A₈ to maintain an electrical connection between the first and second cables while preventing the first and second cables from being tangled. As discussed above, the first cable can be connected to a power source (not shown), e.g., a pool cleaner power supply or an electric outlet, and the second cable can be connected to the pool cleaner unit 103.

In some embodiments, a first group of components, e.g., the first cable, conduit 730a extending from the first cable, the first extension 732a, the central body 731, the first cable collar 707, and the first swivel half 701a, can be attached or fixed relative to each other. In contrast, a second group of components, e.g., the second cable, conduit 730b extending from the second cable, the second extension 732b, and a second cable sleeve, can be attached or fixed relative to each other and can rotate relative to the first group of components about the central vertical axis A₈. Thus, when the first and/or second cable rotates or twists during travel of the swimming pool cleaner 103, the first group of components and the second group of components can rotate relative to each other to prevent tangling of the first and/or second cables.

Turning now to FIG. 22, a fifth embodiment of an exemplary hose swivel 800 is provided for positioning at a water line 102. The hose swivel 800 generally includes a first swivel half 801a and a second swivel half 801b. A first cable can be detachably secured to the first swivel half 801a through a first cable sleeve 804 and can extend to a power source. A second cable can be detachably secured to the second swivel half 801b through a second cable sleeve 802. The second cable can rotate axially about a central vertical axis A₉ relative to the first cable to prevent tangling of the first and second cables. The hose swivel 800 can include a supplemental component 803, e.g., a light, a power outlet, or the like, on the first swivel half 801a.

With respect to FIG. 23, a cross-sectional view of a fifth embodiment of an exemplary hose swivel 800 is provided. The first and second swivel halves 801a and 801b can be securely fastened at a swivel seal 805 with, e.g., threading, adhesives, or the like. An air pocket 817 can be implemented for maintaining the hose swivel 800 at the water line 102. A vertical electrical contact assembly 806 can be positioned inside the hose swivel 800. In particular, the vertical electrical contact assembly 806 can be similar to the vertical electrical contact assembly 715 of FIG. 20A. The vertical electrical contact assembly 806 can include a brush holder 807 for perpendicularly securing a plurality of brushes 808 fabricated from, e.g., copper graphite. A contact PCB 811, including copper trace contacts 809 and trace gaps 810, can be secured to and/or supported by an electrical assembly support 813. The electrical assembly support 813 can further pass through the second cable sleeve 802 and be secured to a second cable attachment member 812. The second cable attachment member 812 can detachably secure a second cable such that when the second cable rotates, the second cable attachment member 812, the electrical assembly support 813 and the contact PCB 811 concurrently axially rotate about a central vertical axis A₉ to reduce entanglement of the second cable. Conduit 818b extending from the second cable can be soldered to the copper trace contacts 809 on the bottom of the contact PCB 811 to electrically connect the second cable to the contact PCB 811. A bushing 814 and first and second lip seals 815a and 815b can further be included to ensure a waterproof seal between the second cable and the second swivel half 801b.

The first cable can be connected in a perpendicular orientation, e.g., about a 90° angle, relative to the central vertical axis A₉. For example, the first cable can be inserted into the first cable sleeve 804 and can be detachably secured by the first cable attachment member 816. The first cable and/or the first cable attachment member 816 can further be electrically wired to the brushes 808 and/or the brush holder 807 to ensure a continuous electrical contact between the first cable and the second cable. For example, conduit 818a extending from the first cable can pass through the first cable attachment member 816 and apertures formed at the top surface of the brush holder 807 and can be soldered to conductive portions connected to brushes 808 to maintain an electrical connection between the first cable and the brushes 808. It should be understood that the first cable can extend to, e.g., a power source. In some embodiments, conduit (not shown) extending from a second cable can pass from the apertures of the brush holder 807 and power the supplemental component 803. The third cable can connect to the second cable attachment member 812 and can extend to, e.g., a pool cleaner unit 103. In some embodiments, the hose swivel 800 can be detachably secured to a skimmer 101 and/or can provide electrical power to the skimmer 101.

In some embodiments, a first group of components, e.g., the first cable, conduit 818a extending from the first cable, brushes 808, the brush holder 807, the first cable attachment member 816, and the first swivel half 801a, can be attached or fixed relative to each other. In contrast, a second group of components, e.g., the second cable, conduit 818b extending from the second cable, the contact PCB 811, the electrical assembly support 813, and the second cable attachment member 812, can be attached or fixed relative to each other and can rotate relative to the first group of components about the central vertical axis A₉. Thus, when the first and/or second cable rotates or twists during travel of the swimming pool cleaner 103, the first group of components and the second group of components can rotate relative to each other to prevent tangling of the first and/or second cables.

Turning to FIGS. 24A and 24B, a sixth embodiment of an exemplary hose swivel 900 is provided for positioning at an in-line and/or fixed unit position between a first cable and a second cable. In particular, the hose swivel 900 generally includes a first swivel half 901a and a second swivel half 901b secured relative to each other at a sleeve seal 905, e.g., matching threading, adhesives, or the like. The first swivel half 901a can include a first cable attachment member 902 with a first cable passage 903 for detachably securing the first cable to the first swivel half 901a. The second swivel half 901b can include a second cable attachment member 904 for detachably securing a second cable to the second swivel half 901b.

The cross-section view of the hose swivel 900 in FIG. 24B shows the first cable sleeve 906 for receiving the first cable and the second cable sleeve 907 for receiving the second cable. The second cable sleeve 907 can be fabricated from, e.g., stainless steel, brass, copper, aluminum, plastic, and the like, and can be configured to axially rotate with the second cable about a central vertical axis A₁₀. A waterproof seal can be created between the second cable sleeve 907 and the second cable attachment member 904 with, e.g., a bushing 908, first and second lip seals 909a and 909b, and the like. An electrical assembly support 910 can be included for supporting at least one of a vertical electrical contact assembly and/or a horizontal electrical contact assembly. Conduit extending from the first and second cables (not shown) can be electrically connected to the vertical electrical contact assembly and/or the horizontal electrical contact assembly to provide an electrical connection between the power source connected to the first cable and the pool cleaner unit 103 connected to the second cable.

FIGS. 25A and 25B show cross-sectional views of a sixth embodiment of exemplary hose swivels 900 in conjunction with a vertical electrical contact assembly 911. The vertical electrical contact assembly 911 can be similar in function and/or configuration to the vertical electrical contact assembly 806 depicted in FIG. 23. In particular, the vertical electrical contact assembly 911 generally includes a brush holder 913, a plurality of brushes 912, a contact PCB 916, a plurality of copper trace contacts 914 and a plurality of trace gaps 915 between the copper trace contacts 914. The contact PCB 916 can be fixedly attached to the second cable attachment member 907 and can be supported by the electrical assembly support 910. Conduit 919a extending from a first cable (not shown) can be electrically connected to the brushes 912 by soldering the conduit 919a to electrical pins 918 fixated in the non-conductive first cable sleeve 906 and further soldering conduit from the electrical pins 918 to conductive contacts of the brushes 912. Conduit can be passed from the electrical pins 918 through apertures formed at a top surface of the brush holder 913 to reach the conductive contacts of the brushes 912. Conduit 919b extending from a second cable (not shown) can be electrically connected to the contact PCB 916 by soldering the conduit 919b to copper trace contacts 914 on the bottom of the contact PCB 916. Thus, when the first and/or the second cable axially rotate about the central vertical axis A₁₀, the contact PCB 916 and the second cable attachment member 907 can also axially rotate about the central vertical axis A₁₀ to reduce the entanglement of the first and/or second cable during movement of the pool cleaner unit 103 along the swimming pool floor and/or walls. As discussed previously, the plurality of brushes 912 can be fabricated from, e.g., copper graphite, and can be spring-loaded to ensure a continuous surface-to-surface contact exists between the brushes 912 and the copper trace contacts 914. FIG. 25B illustrates a cross-sectional view of the hose swivel 900 similar to that of FIG. 25A. In particular, the hose swivel 900 is shown in conjunction with the vertical electrical contact assembly 911 and the conduit 919a, 919b extending from the first and second cables (not shown).

In some embodiments, a first group of components, e.g., the first cable, conduit 919a extending from the first cable, brushes 912, the brush holder 913, the first cable sleeve 906, the electrical pins 918, and the first swivel half 901a, can be attached or fixed relative to each other. In contrast, a second group of components, e.g., the second cable, conduit 919b extending from the second cable, the contact PCB 916, the electrical assembly support 910, and the second cable sleeve 907, can be attached or fixed relative to each other and can rotate relative to the first group of components about the central vertical axis A₁₀. Thus, when the first and/or second cable rotates or twists during travel of the swimming pool cleaner 103, the first group of components and the second group of components can rotate relative to each other to prevent tangling of the first and/or second cables.

Turning to FIG. 26, a cross-sectional view of a sixth embodiment of an exemplary hose swivel 900 is shown in conjunction with a horizontal electrical contact assembly 917 shown diagrammatically (internal components not shown), e.g., a slip ring assembly (see, e.g., SRC Pin Connection Slip Ring, SRC 032 Series, Hangzhou Prosper Mechanical & Electrical Technology Co., Ltd., (2011)). In particular, the horizontal electrical contact assembly 917 includes a central body 920, a first extension 921a rotatably attached relative to the central body 920, and a second extension 921b rotatably attached relative to the central body 920. The first and second extensions 921a and 921b can thereby rotate with respect to the central body 920 about the central vertical axis A₁₀ while maintaining an electrical connection between the first and second extensions 921a and 921b and the central body 920. Each of the first and second extensions 921a and 921b also includes electrical pins extending therefrom, e.g., two conductive pins, which can be used to electrically connect to the first and second cables. For example, conduit 919a extending from the first cable can be electrically connected to the electrical pins extending from the first extension 921a and conduit 919b extending from the second cable can be electrically connected to the electrical pins extending from the second extension 921b. Thus, when either the first and/or second cable rotates axially, the first and/or second extensions 921a and/or 921b can rotate relative to the central body 920 about the central vertical axis A₁₀ to maintain an electrical connection between the first and second cables while preventing the first and second cables from being tangled. As discussed above, the first cable can be electrically connected to a power source (not shown), e.g., a pool cleaner power supply or an electric outlet, and the second cable can be electrically connected to the pool cleaner unit 103.

In some embodiments, a first group of components, e.g., the first cable, conduit 919a extending from the first cable, the first extension 921a, the central body 920, and the first swivel half 901a, can be attached or fixed relative to each other. In contrast, a second group of components, e.g., the second cable, conduit 919b extending from the second cable, the second extension 921b, and a second cable sleeve 907, can be attached or fixed relative to each other and can rotate relative to the first group of components about the central vertical axis A₁₀. Thus, when the first and/or second cable rotates or twists during travel of the swimming pool cleaner 103, the first group of components and the second group of components can rotate relative to each other to prevent tangling of the first and/or second cables.

Turning to FIG. 27, a cross-sectional view of a seventh embodiment of an exemplary hose swivel 1000 is depicted for positioning at a water line 102. The exemplary hose swivel 1000 can be a combination of the exemplary hose swivel 800 of FIG. 23 and the exemplary hose swivel 900 of FIG. 24A and B. As should be understood by those of skill in the art, the first swivel half 801a can be combined with the first swivel half 901a to create a first swivel half 1001a. Thus, the first swivel half 1001a can receive two separate cables. A third cable can be attached to the second swivel half 1001b. In particular, the first cable attachment member 1002 can detachably secure a first cable, the second cable attachment member 1003 can detachably secure a second cable, and the third cable attachment member 1004 can detachably secure a third cable. One of the at least first and second cables can extend to, e.g., a skimmer 101 and/or a power source. The third cable can extend to the pool cleaner unit 103.

The first and second swivel halves 1001a and 100b can be securely fastened at a swivel seal 1008 with, e.g., threading, adhesives, or the like. An air pocket 1019 can be implemented for maintaining the hose swivel 1000 at the water line 102. A vertical electrical contact assembly 1005 can be positioned inside the hose swivel 1000. In particular, the vertical electrical contact assembly 1005 can be similar to the vertical electrical contact assembly 715 of FIG. 20A. The vertical electrical contact assembly 1005 can include a brush holder 1009 for perpendicularly securing a plurality of brushes 1010 fabricated from, e.g., copper graphite. A contact PCB 1015, including copper trace contacts 1011 and trace gaps 1012, can be secured to and/or supported by an electrical assembly support 1004. The electrical assembly support 1004 can further pass through the second cable sleeve 1020 and be secured to a second cable attachment member (not shown). The second cable attachment member can detachably secure a second cable such that when the second cable rotates, the second cable attachment member, the electrical assembly support 1004 and the contact PCB 1015 concurrently axially rotate about a central vertical axis A₁₁ to reduce entanglement of the second cable. Conduit 1006b extending from the second cable can be soldered to the copper trace contacts 1011 on the bottom of the contact PCB 1015 to electrically connect the second cable to the contact PCB 1015. A bushing 1013 and first and second lip seals 1014a and 1014b can further be included to ensure a waterproof seal between the second cable and the second swivel half 1001b.

The first cable can be connected in a perpendicular orientation, e.g., about a 90° angle or a vertical orientation. For example, the first cable can be inserted into the first cable sleeve 1016 oriented perpendicular to the central vertical axis A₁₁ and can be detachably secured by the first cable attachment member 1003. The conduit 1006a extending from the first cable in can further be electrically wired to the brushes 1010 and/or the brush holder 1009 to ensure a continuous electrical contact between the first cable and the second cable. For example, conduit 1006b extending from the first cable can pass through apertures formed at the top surface of the brush holder 1009 and can be soldered to conductive portions connected to brushes 1010 to maintain an electrical connection between the first cable and the brushes 1010. It should be understood that the first cable can connect to the first cable attachment member 1003 and can extend to, e.g., a power source. The second cable can connect to the second cable attachment member 1004 and can extend to, e.g., a pool cleaner unit 103. In some embodiments, the hose swivel 1000 can be detachably secured to a skimmer 101 and/or can provide electrical power to the skimmer 101.

The first swivel half 1001a can also include a cable attachment member 1017 with a first cable passage 1018 for detachably securing the cable to the first swivel half 1001a. For example, conduit 1006a extending from a cable can extend from the apertures formed at the top surface of the brush holder 1009, the conduit 1006a can be soldered to electrical pins 1007 and can further be extended out of the first cable passage 1018. Although illustrated with a vertical electrical contact assembly 1005, it should be understood that a horizontal electrical contact assembly 917 of FIG. 26 can also be implemented.

In some embodiments, a first group of components, e.g., the first cable, conduit 1006a extending from the first cable, brushes 1010, the brush holder 1009, the first cable attachment member 1002, the second cable attachment member 1003, the electrical pins 1007, and the first swivel half 1001a, can be attached or fixed relative to each other. In contrast, a second group of components, e.g., the second cable, conduit 1006b extending from the second cable, the contact PCB 1015, and the third cable attachment member 1004, can be attached or fixed relative to each other and can rotate relative to the first group of components about the central vertical axis A₁₁. Thus, when the first and/or second cable rotates or twists during travel of the swimming pool cleaner 103, the first group of components and the second group of components can rotate relative to each other to prevent tangling of the first and/or second cables.

As previously discussed with respect to FIGS. 8A and 8B, and now, for example, further depicted in FIG. 28, the exemplary hose swivel 200 can be detachably secured to a skimmer 101 to create a first embodiment of an exemplary swivel/skimmer assembly 1100. The skimmer 101 generally includes a first skimmer half 1101a and a second skimmer half 1101b. The second skimmer half 1101b can further include a skimmer flange 1102 which circumferentially protrudes around the periphery of the second skimmer half 1101b. The skimmer flange 1102 generally includes a skimmer fastener path 1103 for receiving and/or detachably securing an exemplary hose swivel 200 and/or any alternative hose swivels discussed herein. The skimmer fastener path 1103 can be configured and dimensioned to form a snap-fit such that a hose swivel 200 can be “snapped” into place. In some embodiments, the skimmer fastener path 1103 can define a C-shaped groove complementary to the outer surface of the hose swivel 200. In some embodiments, the outer surface of the hose swivel 200 can include a circumferential groove (not shown) to create additional support between the hose swivel 200 and the skimmer fastener path 1103. The skimmer fastener path 1103 perimeter can thereby grip the hose swivel 200 from each side to prevent detachment of the hose swivel 200. In addition, the swivel flange 204 can support the hose swivel 200 along the central vertical axis A₇ against the skimmer flange 1102 to prevent detachment from the skimmer 101 by, e.g., translating downwardly through the skimmer fastener path 1103. In some embodiments, such as the hose swivel 200 shown in FIG. 3, the hose swivel 200 can include a skimmer outlet port 109 and the skimmer 101 can include a skimmer inlet port (not shown). Thus, when the hose swivel 200 is inserted into the skimmer fastener path 1103, the skimmer outlet port 109 and the skimmer inlet port can electrically connect, e.g., mate, such that the hose swivel 200 can provide electrical power to the skimmer 101.

With reference now to FIGS. 29A and 29B, a first embodiment of an exemplary swivel/skimmer assembly 1100 is provided from a top and bottom view, respectively. The support provided to the swivel flange 204 by the skimmer flange 1102 can be seen in the top view of FIG. 29A. The bottom view of FIG. 29B illustrates the attachment of the hose swivel 200 to the skimmer fastener path 1103 on the skimmer flange 1102. In addition, the skimmer inlet port 1104 can be seen extending from the center of the second skimmer half 1101b to the hose swivel 200. The skimmer inlet port 1104 can be configured to house therein, e.g., wiring or an electrical conduit for electrically connecting to skimmer outlet port 109 of the hose swivel 100, thereby permitting the hose swivel 100 to provide electrical power to the skimmer 101.

Turning now to FIG. 30, a perspective view of an eighth embodiment of an exemplary hose swivel assembly 1200 positioned at a water line 102 is provided, generally including an exemplary hose swivel 1201, a first cable 1203 and a second cable 1202. It should be understood that the exemplary hose swivel 1201 can be any of one of the exemplary hose swivels discussed herein. The first cable 1203 can electrically connect to the hose swivel 1201 and can extend to a power source, e.g., an electrical outlet, at a periphery of the swimming pool. The second cable 1202 can electrically connect to the hose swivel 1201 and can extend below the water to the pool cleaner unit 103. The hose swivel 1201 can function as described herein to reduce entanglement and/or twisting of the first and second cables 1203 and 1202. In addition, the hose swivel assembly 1200 can optionally include a stiff cable sleeve 1204 for further preventing the first cable 1203 from tangling and/or wrapping around the hose swivel 1201. The cable sleeve 1204 can be fabricated from, e.g., a plastic and/or foam material, and can float at the water line 102. A secondary cable sleeve (not shown) can optionally be positioned extending down from the hose swivel 1201 and surrounding the second cable 1202 to enhance the rotational abilities of the second cable 1202 inside the hose swivel 1201. It should be understood that the dimensions, e.g., diameter, length, and the,like, of the cable sleeve 1204 can be varied to accommodate the desired configuration of the exemplary hose swivel 1201.

With reference to FIG. 31, a perspective view of a ninth embodiment of an exemplary hose swivel 1300 is provided. The hose swivel 1300 generally includes a swivel body/housing defined by a first swivel half 1301, a second swivel half 1302 and a swivel body 1303. In some embodiments, the swivel body/housing of the hose swivel 1300 can be fabricated from a plastic, e.g., high-density polyethylene (HDPE), and the like, to assist in flotation of the hose swivel 1300. However, it should be understood that alternative materials of fabrication can be used. The first and second swivel halves 1301 and 1302 can be configured to receive and/or secure first and second cables 1304 and 1305, respectively, such that the first and second cables 1304 and 1305 can axially rotate relative to each other about a central vertical axis A₁₂. In some embodiments, an outer surface of the swivel body 1303 can include a circumferential groove configured and dimensioned to permit attachment of the hose swivel 1300 to, e.g., a skimmer 101, a pool cleaner unit 103, and the like. The first cable 1304 can electrically connect the hose swivel 1300 to a power source (not shown), e.g., a pool cleaner power supply or an electric outlet, and the second cable 1305 can electrically connect the hose swivel 1300 to the pool cleaner unit 103. The first swivel half 1301, the second swivel half 1302 and the swivel body 1303 can be configured and dimensioned to house the components necessary for creating an electrical connection between the first and second cables 1304 and 1305.

FIG. 32 shows an exploded perspective view of a ninth embodiment of an exemplary hose swivel 1300 to illustrate the internal components of the hose swivel 1300. In some exemplary embodiments, at least some of elements 1306 rotate relative to at least some of elements 1307 about the central vertical axis A₁₂. As would be understood by those of ordinary skill in the art, in some embodiments, elements 1306 axially rotate relative to elements 1307 while maintaining an electrical connection between the first and second cables 1304 and 1305. For example, in some exemplary embodiments, slip seals 1311, bushing 1312, electrical assembly support 1313, and swivel ring 1314 remain fixedly attached relative to each other, while the remaining elements of 1306 axially rotate. In some exemplary embodiments, the rotational aspect of the hose swivel 1300 is provided internally by the vertical electrical contact assembly 1316. First and second cables 1304 and 1305 can be surrounded by seals 1308 at the openings of the first and second swivel halves 1301 and 1302 to create a sealed and/or waterproof contact, such that entry of liquid into the hose swivel 1300 is prevented. First and second cables 1304 and 1305 can further include male terminals 1309a, 1309b, e.g., conduit or wires extending from the first and second cables 1304 and 1305, configured and dimensioned to mate with female terminals (not shown) within the hose swivel 1300. Male terminals 1309a, 1309b and female terminals can mate to maintain an electrical connection between the first and second cables 1304 and 1305 and the vertical electrical contact assembly 1316, e.g., a slip ring, and the like. Those of ordinary skill in the art should understand that the vertical electrical contact assembly 1316 can be substantially similar to as the electrical contact assembly 917 of FIG. 26. For example, the vertical electrical contact assembly 1316 can be a slip ring assembly (see, e.g., SRC Pin Connection Slip Ring, SRC 032 Series, Hangzhou Prosper Mechanical & Electrical Technology Co., Ltd., (2011)).

The exemplary hose swivel 1300 can include an electrical assembly support 1313 configured and dimensioned to support a vertical electrical contact assembly 1316. The electrical assembly support 1313 can include threads for mating with internal threads of the swivel body 1303. An attachment member 1310, e.g., a sleeve fabricated from stainless steel, brass, copper, aluminum, plastic, and the like, can be positioned within the electrical assembly support 1313 and can be configured to axially rotate with the first cable 1304. In some embodiments, the attachment member 1310 can be fixated to the first swivel half 1301 by complementary threads and the first cable 1304 can axially rotate independently from the attachment member 1310. In particular, threads on an outer surface of the attachment member 1310 can mate with internal threads of the first swivel half 1301. In some embodiments, the internal threads of the first swivel half 1301 and the second swivel half 1302 can correspond to threads on a motor box (not shown) such that a cable with a motor box connection can be threaded into the first swivel half 1301.

Slip seals 1311 and bushing 1312 can be implemented to create a seal between the attachment member 1310 and the electrical assembly support 1313 while allowing the first cable 1304 to axially rotate relative to the second cable 1305. A swivel ring 1314, e.g., a gasket, can be implemented to create a waterproof seal between the swivel body 1303 and the electrical assembly support 1313. A retaining ring 1315 can be utilized in conjunction with a receiving groove along an outer surface of the attachment member 1310 such that the retaining ring 1315 can mate with the receiving groove to maintain the attachment member 1310 in a desired position relative to the electrical assembly support 1313 and/or the vertical electrical contact assembly 1316.

Turning now to FIG. 33, a cross-sectional view of a ninth embodiment of an exemplary hose swivel 1300 is provided. In particular, FIG. 33 illustrates mating between threads located on the first and second swivel halves 1301 and 1302, the electrical assembly support 1313, the attachment member 1310 and the swivel body 1303. In some exemplary embodiments, a sealant can be utilized on the threads to ensure a waterproof seal. The swivel body 1303 can include channels formed therein for receiving and/or supporting the vertical electrical contact assembly 1316. The attachment member 1310 can be positioned against the vertical electrical contact assembly 1316 to maintain the vertical electrical contact assembly 1316 in the desired orientation and to swivel around the vertical electrical contact assembly 1316 with the first cable 1304. It should be noted that the vertical electrical contact assembly 1316 is shown diagrammatically (internal components not shown). In some embodiments, the hose swivel 1300 can include a stainless steel sleeve (not shown) to at least partially cover the attachment member 1310 such that a low friction, durable and/or smooth seal contact surface is formed between the attachment member 1310 and the bushing 1312.

Female terminals 1317a, 1317b can be configured to receive male terminals 1309a, 1309b to maintain an electrical connection between the first and second cables 1304 and 1305 and the vertical electrical contact assembly 1316. In some embodiments, additional support, e.g., one or more KEVLAR® fiber ties, and the like, can be passed through the first and/or second cables 1304 and 1305 and secured to a structure within the hose swivel 1300 to increase the amount of pull force permitted on the first and second cables 1304 and 1305. For example, the additional support can extend the length of the first and second cables 1304 and 1305 and allow a pull force to be imparted on the first and second cables 1304 and 1305 without causing undesired separation of the first and second cables 1304 and 1305 from the hose swivel 1300. In some embodiments, the male terminals 1309a, 1309b can include an attachment (not shown), e.g., a metal crimp washer, a metal crimp sleeve, a KEVLAR® fiber tie, and the like, positioned around the male terminals 1309a, 1309b to provide additional pull force support to the male terminals 1309a, 1309b. For example, the attachment around the male terminals 1309a, 1309b can be dimensioned to abut the seal 1308, thereby preventing the male terminals 1309a, 1309b from being pulled out of the hose swivel 1300.

In some exemplary embodiments, the vertical electrical contact assembly 1316 can be configured to contain rotating extensions to allow first and second cables 1304 and 1305 to rotate relative to each other while maintaining an electrical connection therebetween. For example, the vertical electrical contact assembly 1316, e.g., a brush contact slip ring, can define a central body 1318 and a first and second extension 1319a and 1319b. At least one of the first and second extensions 1319a and 1319b can rotate relative to the central body 1318. Thus, the male terminals 1309a, e.g., conduits extending from the first cable 1304, can be electrically connected to female terminals 1317a. In some embodiments, male terminals 1309a and/or the female terminals 1317a can be electrically connected to the electrical pins extending from the first extension 1319a. Similarly, the male terminals 1309b, e.g., conduits extending from the second cable 1305, can be electrically connected to female terminals 1317b. In some embodiments, male terminals 1309b and/or the female terminals 1317b can be electrically connected to the electrical pins extending from the second extension 1319b. Thus, if the first cable 1304 and/or second cable 1305 rotate relative to the hose swivel 1300, the first and/or second extensions 1319a and 1319b, respectively, can rotate relative to the central body 1318 of the vertical electrical contact assembly 1316.

In some embodiments, a first group of components, e.g., all of the components of the hose swivel 1300 except the second extension 1319b, the female terminals 1317b, the male terminals 1309b, and the second cable 1305, can be attached or fixed relative to each other. In contrast, a second group of components, e.g., the second extension 1319b, the female terminals 1317b, the male terminals 1309b, and the second cable 1305, can be attached or fixed relative to each other and can rotate relative to the first group of components about the central vertical axis A₁₂. Thus, when the first and/or second cable 1304 and/or 1305 rotates or twists during travel of the swimming pool cleaner 103, the first group of components and the second group of components can rotate relative to each other to prevent tangling of the first and/or second cables 1304 and/or 1305.

The point of rotation in the exemplary hose swivel 1300 thereby occurs at the vertical electrical contact assembly 1316. Tangling of the first and/or second cables 1304 and 1305 is thereby prevented while an electrical connection between the first and second cables 1304 and 1305 is maintained through the vertical electrical contact assembly 1316. In some embodiments, the exemplary hose swivel 1300 can be detachably secured to a skimmer 101 at a water line. For example, the skimmer 101 can include a groove for receiving the swivel 1300, the swivel 1300 can include a flange for providing support against the skimmer 101, the swivel 1300 can include a groove for a press fit for accommodating the groove of the skimmer 101, and the like. FIG. 34 shows an exploded cross-sectional view of the exemplary hose swivel 1300.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A modular electric hose swivel for reducing entanglement of a swimming pool cleaner power cable, comprising:
a swivel body that includes a first swivel half and a second swivel half;
wherein the first swivel half is configured to receive a first cable and the second swivel half is configured to receive a second cable;
wherein the first swivel half and the second swivel half provide a continuous electrical contact between the first cable and the second cable; and
wherein the swivel body detachably secures to a skimmer.

2. The modular hose swivel of claim 1, wherein the swivel body detachably secures to a skimmer at a water line.

3. The modular hose swivel of claim 1, wherein the first cable and the second cable are axially rotatable relative to each other.

4. The modular hose swivel of claim 1, wherein the swivel body detachably secures to a flange protruding circumferentially from the skimmer.

5. The modular hose swivel of claim 4, wherein the flange includes a groove complementary to an outer surface of the swivel body configured and dimensioned to create a snap fit between the groove and the swivel body.

6. The modular hose swivel of claim 1, wherein the first swivel half comprises a skimmer auxiliary outlet port for providing electrical power from the swivel body to the skimmer.

7. The modular hose swivel of claim 1, wherein the first cable electrically connects the swivel body to a power source.

8. The modular hose swivel of claim 1, wherein the second cable electrically connects the swivel body to a pool cleaner unit.

9. The modular hose swivel of claim 1, wherein the continuous electrical contact is at least one of (i) a vertical electrical contact assembly and (ii) a horizontal electrical contact assembly.

10. A method of reducing entanglement of a swimming pool cleaner power cable, comprising:
providing a swivel body that includes a first swivel half and a second swivel half;
detachably securing the first swivel half to a first cable and the second swivel half to a second cable; and
detachably securing the swivel body to a skimmer;
wherein the first swivel half and the second swivel half provide a continuous electrical contact between the first cable and the second cable.

11. The method of claim 10, comprising providing electrical power to the skimmer from the swivel body through a skimmer auxiliary outlet port located on the swivel body.
